(19) United States
(12) Patent Application Publication
(10) Pub. No.: US 2009/0089127 A1
(43) Pub. Date: Apr. 2, 2009

(54) Techniques for utilizing decision criteria in a communication plan

(76) Inventors: Christian Seifert, Durham, NC (US); David Brophy, Beaumaris (AU); David Carmer, Cary, NC (US); Jason Figge, Pittsboro, NC (US); Anish Shah, Apex, NC (US); Dan Willoughby, Raleigh, NC (US)

Correspondence Address: JAMES M. STOVER;TERADATA CORPORATION, 2835 MIAMI VILLAGE DRIVE, MIAMISBURG, OH, 45342, US

(21) Appl. No.: 11/315,805

(22) Filed: Dec. 22, 2005

(51) Int. Cl. G06Q 10/00; G06Q 99/00

(52) U.S. Cl. 705/8; 705/1; 705/10; 705/7

(57) ABSTRACT

Techniques are presented for utilizing decision criteria within a communication plan. As a communication plan is processed a new decision step may be dynamically added to the processing. The new decision step breaks a set of incoming leads into a plurality of different customer groups. Each group may then be dynamically assigned to one or more actions within the communication plan.

### FIELD

The invention relates generally to customer relationship management (CRM) and more particularly to techniques for utilizing decision criteria in a communication plan.

### BACKGROUND

Modern day marketing has significantly evolved with the advent of the information age. Today, enterprises collect, analyze, and mine a wide variety of information about customers for a variety of marketing purposes. The wealth of potential available information with technology may also present some challenges to marketers.

For example, consider a marketer engaged in direct campaign with customers. During the campaign and as the marketer interacts with customers, information and decisions must be made in real time by the marketer. However, some times a decision may not have enough information to be intelligently and properly made by the marketer. Often the plan associated with the campaign provides no ability for the marketer to slow things down or delay things so that the marketer can more qualitatively conduct the campaign based on the marketer's intuition or skill level.

Another problem that may be encountered is that a marketer may discover during a campaign that there is a pattern developing with the customers, such that if the marketer had the ability to alter the plan for the campaign the results may be more favorable to an enterprise to which the campaign is associated.

In fact, most campaigns follow predefined communication plans and these plans flow in a predefined manner. The marketers or those conducting the campaigns have little ability to alter the flow of communication. Consequently, many campaigns may not be conducted in the spirit with which they were intended by an enterprise.

Thus, it can be seen that improved techniques for processing communication plans with customers are desirable.

### SUMMARY

In various embodiments, techniques for utilizing decision criteria within a communication plan are provided. In an embodiment, a communication plan is acquired for interacting with customers. Also, a desired step is selectively identified within the communication plan and a new decision step is inserted in front of the identified desired step within the communication plan. The new decision step separates the customers into a plurality of groups, where each group is assigned to one or more actions within the communication plan.

### BRIEF DESCRIPTION OF THE DRAWINGS

FIG. 1 is a diagram of a method for utilizing decision criteria in a communication plan, according to an example embodiment.

FIG. 2 is a diagram of another method for utilizing decision criteria in a communication plan, according to an example embodiment.

FIG. 3 is a diagram of a communication plan processing system, according to an example embodiment.

### DETAILED DESCRIPTION

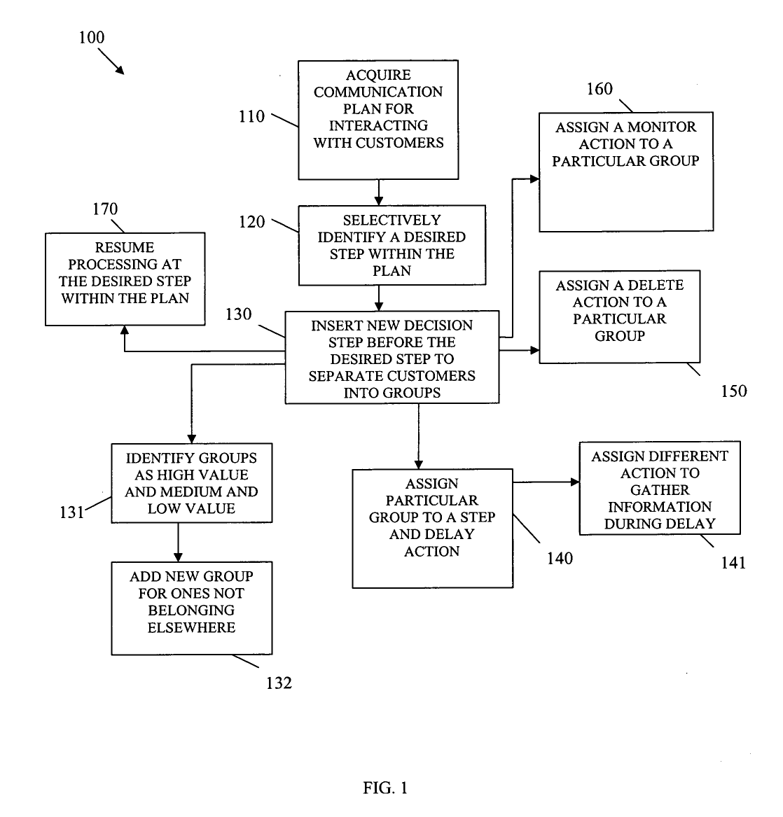

FIG. 1 is a diagram of a method 100 for utilizing decision criteria in a communication plan, according to an example embodiment. The method 100 (hereinafter “communication editing service”) is implemented in a machine-accessible or computer-readable medium and is accessible over a network. The network may be wired, wireless, or a combination of wired and wireless.

As used herein a “data store” may include a database, a collection of databases organized as a data warehouse, a directory, a collection of directories, or various combinations of these items. According to an embodiment, the data store and its use herein refers to a Teradata® warehouse product and service, distributed by NCR Corporation of Dayton, Ohio.

A “communication plan” refers to a script or business rules that are processed in an automated manner and that interacts with an operator. The operator may be a marketer or the operator may itself be another automated program or service. The communication plan includes steps and at these steps conditions and events are evaluated and determinations are made as to how and where to next proceed, if at all, within the communication plan's processing flow.

A “dialogue” is an interaction that a marketer engages in with a customer of an enterprise. This dialogue may occur in person at a business location of the enterprise, may occur over a phone, may occur via on-line chat or instant messaging (IM), and/or may occur via electronic mail (email) messages. A dialogue is not restricted to any particular communication channel; it is instead open to any channel that a customer can conceive of, such as and by way of example only, email, regular postal mail, call centers, and the like.

The dialogue may be initiated by the marketer pursuant to a survey, campaign, or follow-up to a problem resolution. Alternatively, the dialogue may be initiated by the customer.

During a dialogue with a customer, a marketer or operator may enlist the services of a communication plan. That is, the dialogue itself may be associated with a specific course of action(s) defined by the enterprise and encapsulated within the data store as a dialogue object, which is referred to as the communication plan.

It is within this context that the processing of the communication editing service is discussed with reference to the FIG. 1. At 110, the communication editing service acquires a communication plan for interacting with customers. This communication plan, as was described above, represents how a dialogue with customers should proceed for a given marketing campaign or other defined customer interaction. The communication plan may reside in a data store and may be acquired via a query.

At 120, the communication editing service selectively identifies a desired step within the communication plan. This may be done by receiving direction from an operator interfaced to the communication editing service. Alternatively, if the operator is an automated service, this may be done via an application programming interface (API), where the automated operator identifies the desired step on behalf of the communication editing service. The desired step may be any selected step within the communication plan, which the operator identifies for the editing service.

At 130, the communication editing service inserts a new decision step before the identified desired step within the communication plan. This decision step utilizes predefined decision criteria that when processed with the communication plan separates incoming leads or customers that are destined from the desired step, within the communication plan, into a plurality of groups. Each group is assigned within the decision criteria to one or more subsequent actions.

According to an embodiment, the decision step takes a set of incoming leads and separates them into multiple groups by leveraging the split functionality of segmentation. This may be referred to as a split template. The segmentation is associated with predefined customer relationship management (CRM) categories for customers. Moreover, each segmentation group may be assigned within to be associated with an appropriate action within the communication plan.

So, in some cases, at 131, the groups or customer segmentation categories may be identified as high value customers and as a combined medium to low value group of customers. Furthermore, at 132, a new group may also be added such that some customers are associated with a catchall or remainder group that does not belong to the high value or medium and low value categories.

According to an embodiment, at 140, the communication editing service may assign, in response to the decision step and its decision criteria, a particular group to a step and delay action. During a step and delay action, a group of customers or a particular customer may be moved back to the same decision step within the communication plan. Essentially, the lead or group associated with this action is stalled for a defined amount of time before it is again re-evaluated within the communication plan. During this delay, another action, at 141, may be assigned to the group that is being stalled and that action may gather information during the delay. This gives the operator time to collect information about the group or lead that may not be available at one point in time during the processing of the communication plan, but which may become available if the group or lead is stalled and attempts are made to collect the additional information.

In another embodiment, at 150, communication editing service may use the decision criteria of the decision step to assign a delete action to a particular group. That is, if a particular group is identified within the conditions associated with the decision criteria of the decision step, which satisfies a termination condition, then that particular group may be terminated when the communication plan processes.

In yet another embodiment, at 160, the communication editing service may use the decision criteria of the decision step to assign a monitor action to a particular group. A monitor action may perform specialized evaluations of events and conditions defined within the communication plan for the particular group associated with it.

Monitor actions are used to determine if a particular customer or particular group has done what they have agreed to do. For example, if in a communication a lead agrees to buy a mortgage plan then the editing service can monitor for that event to in fact occur. If it does occur, then a specified action will be applied to the lead.

The communication editing service may be used to edit communication plans that are not processing and residing within the data store. Alternatively, the communication editing service may be dynamically used to alter communication plans that are processing in real time. The communication editing service permits an operator to insert a decision step before a identified desired step within the communication plan, which breaks leads or customers up into segments or groups. Each group assigned to one or more actions. In some cases, the action may be to simply delay a particular lead while more information is gathered or collected. In other cases, a group may be terminated from the communication play or monitored for further action.

Finally, at 170, the editing service resumes or links the decision step and its split template processing back to the desired step within the communication plan. So, after the decision step is processed, the normal expected processing of the desired step that was interrupted is resumed and processed according to its instructions included within the communication plan. So, the added decision step results in a processing break within the communication plan, that processing break is re-linked at 170 to resume its normal flow within the communication plan after the decision step processing is accounted for.

It is noted that any desired action may be used and any desired segmentation of customers can be configured with the teachings presented herein. The examples were provided for purposes of illustration to demonstrate how a novel decision step may be inserted before a desired step within a communication plan to alter the processing of that communication plan. The altered communication plan processing may be achieved statically or dynamically as the communication plan is being processed and evaluated by an operator.

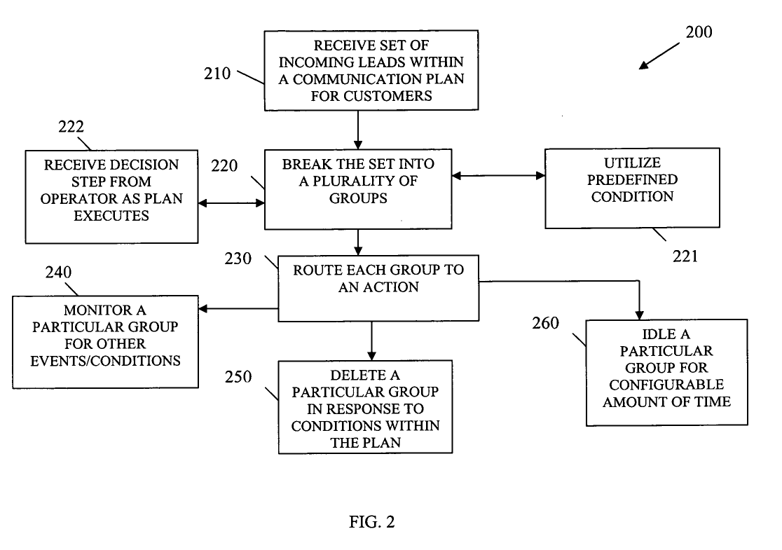

FIG. 2 is a diagram of another method 200 for utilizing decision criteria in a communication plan, according to an example embodiment. The method 200 (hereinafter “communication plan processing service”) is implemented in a machine-accessible and readable medium and is accessible over a network. The network may be wired, wireless, or a combination of wired and wireless. In an embodiment, the communication plan processing service represents a different processing perspective of the editing service represented by the method 100 of FIG. 1.

That is, the editing service represented by the method 100 of the FIG. 1 depicts how a communication plan may be recalled and edited. Conversely, the communication plan processing service represents how a communication that is dynamically and in real time being processed may be edited to include a new decision step.

According, at 210, the communication plan processing service receives a set of incoming leads within a communication plan, which is being processed. So, an operator (manual or automated service) is inspecting a communication plan that is processing. An example communication plan may be associated with a marketing campaign.

The operator activates the communication plan processing service my requesting that a decision step be inserted before a step identified within the communication plan. This instruction causes the communication plan processing service to be initiated while the communication plan is being processed and causes the communication plan processing service to receive a set of incoming leads that were destined for the particular step within the communication plan for which a new decision step is being interjected. The leads are associated with customers. That is, the leads may be viewed as a set of customer identifiers that may be used to access other information about the customers within a data store.

At 220, the communication plan processing service breaks the set of incoming leads into a plurality of groups. According to an embodiment, at 221, this may entail utilizing a predefined condition or set of decision criteria. The condition or criteria defines how the set of incoming leads is to be decomposed and grouped.

In another embodiment, at 222, the communication plan processing service may receive the decision step from the operator as the plan executes. That is, the decision criteria or condition that defines how to break the set of incoming leads up may be dynamically supplied by the operator to the communication plan processing service. In response to this, the communication plan processing service dynamically and in real time evaluates the decision step and breaks the set of incoming leads up into the appropriate groups.

At 230, communication plan processing service routes each group to an action within the communication plan. Two or more groups may be assigned to the same action. Alternatively, each different group may be assigned to unique and different actions. Again, the decision criteria or condition may dictate which groups are assigned to which actions within the communication plan.

A variety of pre-established actions may be dynamically assigned to the groups. For example, at 240, a monitor action may be assigned to a particular group. With a monitor action, predefined events or conditions are monitored for purposes of determining what next to do with a particular group within the processing communication plan.

As another example, at 250, a particular group may be entirely deleted from any further processing within the communication plan. Thus, if low value customers are associated with a low value group, then the communication plan may dictate that the low value customer group is removed from any further processing within the communication plan.

In still another example, at 260, the communication plan processing service may idle a particular group for a configurable amount of time within the communication plan. This is particularly beneficial with marketing campaigns when certain beneficial information about a customer segment (particular group) is not immediately available but may become available if given a little more time.

So, an operator could essentially interrupt the processing of a communication plan and insert a new decision step with new decision criteria. The communication plan processing service identifies a segment from incoming leads destined for a particular step within the communication plan and assigns them to an idle action for a configurable period of time and at the conclusion of such time that group is released back to the original step within the communication plan to which they were originally to be processed. During the idle period other actions may be used to continually attempt to gather needed or desired information for that customer group, which is being idled. If the information is still not available, then another decision step and idle action may be processed by the operator, if this is desired. This process may repeat as many times as desired.

One now appreciates how the processing of a communication plan may be dynamically altered and customized with new decision steps that permit customers to be segmented into desired groups and each group assigned to one or more actions within the communication plan. The processing may be inserted before an existing step within the communication plan and provides for more customized control by the operator of the communication plan, which is being processed.

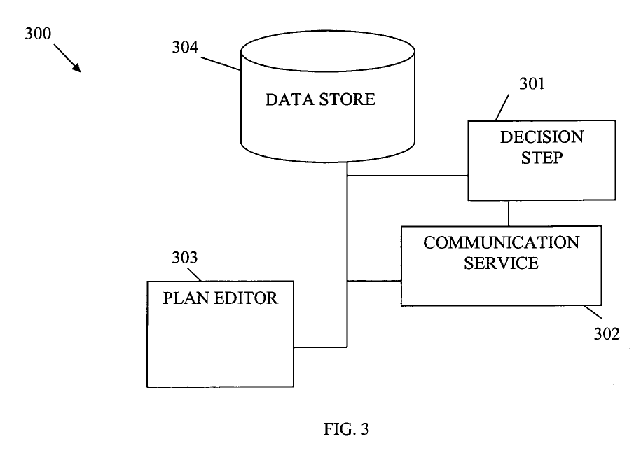

FIG. 3 is a diagram of a communication plan processing system 300, according to an example embodiment. The communication plan processing system 300 is implemented in a machine-accessible and readable medium and is operational over a network. The network may be wired, wireless, or a combination of wired and wireless. In an embodiment, portions of the communication plan processing system 300 implements, among other things the services represented by the methods 100 and 200 of the FIGS. 1 and 2, respectively.

The communication plan processing system 300 includes a decision step 301 and a communication service 302. In some embodiments, the communication plan processing system 300 may also include a plan editor 303 and a data store 304. Each of these will now be discussed in turn.

The decision step 301 is a set of logic or instructions that are inserted before existing steps that exist within a communication plan. The decision step 301 includes decision criteria that define the conditions or events for breaking incoming leads or customers into custom defined groups or segments and then what to do with each of those segments within a communication plan when they are encountered.

The decision step 301 may be prefabricated within a communication plan as it exists within a data store 305 or it may be dynamically inserted into a communication plan just before an identified step within that communication plan as the communication plan is processed by a communication service 302.

The communication service 302 dynamically and in real time processes communication plans and if it encounters and existing decision step 301 or one dynamically supplied, then the communication service 302 interrupts the processing of an associated step within the communication plan and processes the decision step 301 and its decision criteria.

When the decision step 301 is processed with a communication plan, incoming leads (customers) are broken into configurable groups (segments) and each group assigned to an action that is also defined within the decision step 301.

Some example customer groupings may include high value customers, medium value customers, low value customers, and customers that do not fall within any particular grouping (catchall or remainder grouping). The decision criteria or search parameters associated with identifying the groupings may also be included within the decision step 301 and its logic.

As was mentioned, each group may also be assigned to an action. Some example actions may include continue to monitor a particular grouping of customers, delete or terminate a grouping of customers from being processed with the communication plan, and idle a particular grouping of customers for a configurable amount of time.

If an idle action occurs other actions may continue to process in parallel that attempt to continually gather information that may be relevant to further processing the idle group within the communication plan when the idle group is subsequently released for processing. In some cases, the idle period may be dynamically interrupted upon the detection of an event, such as another action notifying the communication service 302 that relevant information for processing the idle group has now been acquired. Thus, the idle period may be defined by a configurable elapsed period of time or by the raising of some predefined event.

It is understood that any action may be assigned to the groupings. So, any desired and custom action may be associated with a particular grouping of customers within the decision step 301 and assigned for processing when it is appropriate to do so by the communication service 301.

According to an embodiment, the decision step 301 may be dynamically received from an operator as that operator interacts with a processing communication plan, which is being executed by the communication service 302. Again, the operator may be a marketer or it may be another automated service.

In an embodiment, the communication plan processing system 300 may also include a plan editor 303. The plan editor 303 permits the communication plan to be created and modified with the decision step 301. Some example operations that a plan editor 303 may take were described above with respect to the editing service represented by the method 100 of the FIG. 1.

In yet other embodiments, the communication plan processing system 300 may also include a data store 304. The data store 304 may be a database, a collection of databases organized as a data warehouse, a directory, a collection of directories, or various combinations of the same. The data store 304 houses information that is acquired and processed by the communication service 302 when the communication plan is processed. The data store 304 may also house the communication plans and the decision steps 301. The decision steps may be included directly within the communication plans or referenced within the communication plans and dynamically acquired by the communication service 302.

It is now understood how conventional communication plan processing may be altered to provide more control to an operator by a decision step mechanism having decision criteria. A more granular level of control can then be dynamically achieved with the processing of a communication plan and it can be customized according to the needs and desires of the operator.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
acquiring a communication plan for interacting with customers;
selectively identifying a desired step within the communication plan; and
inserting a new decision step in front of the identified desired step within the communication plan, wherein the new decision step separates the customers into a plurality of groups and each group assigned to one or more actions within the communication plan.

2. The method of claim 1, wherein inserting further includes identifying the plurality of groups as high value customers and as medium and low value customers.

3. The method of claim 2 further comprising, adding a new group to the plurality of groups for selective ones of the customers that do not fall within the high value or medium to low value customer groups.

4. The method of claim 1 further comprising, assigning a particular group to a step and delay action, wherein the step and delay action stalls the particular group within the communication plan during processing of the communication plan and then re-associates the particular group with the desired step.

5. The method of claim 4 further comprising, assigning a different action during the step and delay action that when processed with the communication plan attempts to gather additional information about the particular group during the step and delay action and feeds that additional information to the desired step when the particular group is released to the desired step within the communication plan.

6. The method of claim 1 further comprising, assigning a delete action to a selective one of the groups within the communication plan if the selective one of the groups conform to one or more conditions during processing of the communication plan.

7. The method of claim 1 further comprising, assigning a monitor action to a selective one of the groups within the communication plan, wherein the monitor action when processed within the communication plan evaluates other events or conditions and in response to those events or conditions makes further decisions within the communication plan with respect to the selective one of the groups.

8. A method, comprising:
receiving a set of incoming leads within a communication plan for customers;
breaking the set into a plurality of groups; and
routing each of the groups to one or more actions within the communication plan.

9. The method of claim 8 further comprising, deleting a particular group in response to conditions within the communication plan.

10. The method of claim 9 further comprising, idling a particular group for a configurable amount of time in response to conditions within the communication plan.

11. The method of claim 8 further comprising, monitoring a particular group for other events or conditions before routing that particular group.

12. The method of claim 8, wherein breaking further includes utilizing a predefined condition that when evaluated against the set of incoming leads produces the plurality of the groups.

13. The method of claim 8, wherein breaking further includes receiving a decision step from an operator as the communication plan executes, wherein the decision step includes instructions for performing the breaking of the set of incoming leads into the plurality of the groups.

14. A system comprising:
a decision step within a communication plan; and
a communication service, wherein the communication service dynamically processes the communication plan and when the decision step is encountered or received, the communication service breaks a set of incoming leads into a plurality of groups, each group routed to one or more actions within the communication plan.

15. The system of claim 14 further comprising, a plan editor that permits the communication plan to be created or modified with the decision step.

16. The system of claim 14 further comprising, a data store to house the communication plan, wherein the communication service accesses the data store to evaluate and process the communication plan.

17. The system of claim 14, wherein the decision step is to be dynamically received from an operator while the communication service processes the communication plan.

18. The system of claim 14, wherein the decision step includes a condition that when dynamically evaluated by the communication service produces the plurality of the groups.

19. The system of claim 18, wherein the condition defines the groups as at least one of high value customers, medium value customers, low value customers, and remaining customers not having enough information to be associated with another one of the groups.

20. The system of claim 14, wherein the one or more actions include at least one of a delay action, a continue-to-monitor action, and a delete action.
